(19) United States
(12) Patent Application Publication
(10) Pub. No.: US 2007/0011496 A1
(43) Pub. Date: Jan. 11, 2007

(54) Method and system for design and analysis of fastened joints

(75) Inventors: Nausheen Ahmad, Dunlap, IL (US); Brian Karl Holfelner, Chillicothe, IL (US); O.W. Williams JR., Peoria, IL (US); Paul Gaylen Robison, Chillicothe, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Caterpillar Inc.

(21) Appl. No.: 11/406,263

(22) Filed: Apr. 19, 2006

Related U.S. Application Data
(60) Provisional application No. 60/696,956, filed on Jul. 6, 2005.

(51) Int. Cl. G06F 11/00

(52) U.S. Cl. 714/39

(57) ABSTRACT

A computer system for analyzing fasteners and fastened joints includes a display and a processor. The processor may be configured to provide a first interface and a second interface to the display, and receive, via the first or second interface, a set of parameters associated with a component to be fastened. Further, the processor may be configured to provide the set of parameters to an analysis tool, execute instructions associated with the analysis tool, and provide an output of the analysis tool to the display via either the first or second interface. The first interface may include at least one data entry form, and the second interface may be associated with a computer aided drafting tool.

Applicants claim the right to priority under 35 U.S.C. §119(e) based on U.S. Provisional Patent Application No. 60/696,956, entitled “METHOD FOR DESIGN AND ANALYSIS OF FASTENED JOINTS,” filed Jul. 6, 2005 which is expressly incorporated herein by reference in its entirety.

### TECHNICAL FIELD

This disclosure relates generally to methods and systems for designing and analyzing fastened joints, and more particularly, to methods and systems for designing and analyzing fasteners applied to joints.

### BACKGROUND

Manufacturing and assembly processes frequently employ the use of fasteners, such as bolts, to fasten components together. It is imperative for the quality and useful life of the completed product that the fasteners be adequate for the job. For example, the engagement type of the joints, the environment that the joints and fasteners might be subjected to (such as corrosion), the condition of applied finishes (such as paint), geometrical constraints, design rules, and the like, all contribute to the need for adequate fastener design. On the other hand, over-design of fasteners leads to increased and unnecessary costs. Balancing adequacy of the fastened joints with costs is often difficult to achieve.

In the past, reliance was placed on the expertise and experience of design engineers to select the proper fastener for the job. However, the process of specifying and analyzing potential fasteners can be time consuming and may not fully utilize the skills of an experienced engineer. Design engineers typically have numerous other tasks that may better utilize their skills and, therefore, may prefer to delegate initial fastener specification to analysts. However, in the absence of an appropriate tool for fastener specification, analysts may not be capable of performing the associated tasks in place of an engineer. Further, the lack of such a tool may result in a loss of uniformity within the design process regardless of whether an engineer or an analyst is responsible for the specification of fasteners.

The design process itself offers little in the way of a solution. Typical computer-based design programs are isolated from other design programs, and thus produce inconsistent design choices of fastener requirements. Design programs also tend to be broad in scope, and thus may not address the myriad of specific issues that arise with respect to fastener needs. Further, design programs typically do not include functionality for analysis of a completed design, thereby requiring additional software and integration.

At least one fastener design and analysis program exists. For example, U.S. Patent Publication 2004/0194019 (the '019 publication) discloses an analysis tool for specifying and analyzing fasteners for a fastened joint. While the '019 publication may discuss iterative analysis of fasteners and a fastened joint, the disclosed process has several shortcomings. For example, it is limited to analysis of data values entered by a user and does not integrate with a computer aided drafting tool. Further, it does not provide listings of potential fasteners, and the tool requires switching between numerous “function” pages, making it difficult to navigate.

The disclosed concept is directed to overcoming one or more of the problems as set forth above.

### SUMMARY OF THE INVENTION

According to one embodiment, a computer system is disclosed. The computer system may include a display and a processor. The processor may be configured to provide a first interface and a second interface to the display and receive, via the first or second interface, a set of parameters associated with a component to be fastened. Further, the processor may be configured to provide the set of parameters to an analysis tool, execute instructions associated with the analysis tool, and provide an output of the analysis tool to the display via either the first or second interface. The first interface may include at least one data entry form, and the second interface may be associated with a computer aided drafting tool.

In another embodiment, a method for selectively designing and analyzing a fastener for a joint is disclosed. The method may include running a software analysis tool configured to provide a first interface and a second interface, wherein the first interface includes at least one data entry form, and the second interface is associated with a computer aided drafting tool. The method may also include selecting one of the first and the second interface, and providing, via the selected interface, a set of parameters related to a component to be fastened, and selecting a fastener from a list of potential fasteners. Further, the method may include initiating an analysis of the selected fastener and the component and reviewing, within the selected interface, a set of results generated by the analysis.

In yet another embodiment, a computer-readable medium including instructions for performing a method for designing and analyzing a fastener for a joint is disclosed. The computer-readable medium may include instructions for receiving a selection of an interface from a group of interfaces, wherein the group of interfaces includes a computer aided drafting tool interface and a data entry form interface. The computer-readable medium may also include instruction for receiving, via the selected interface, a set of parameters related to a component to be fastened and receiving a selection of a fastener for the joint. Further, the computer-readable medium may include instructions for analyzing the fastener based on the set of parameters and the component to be fastened, wherein analyzing includes generating a set of results and outputting the set of results to the selected interface.

### BRIEF DESCRIPTION OF THE DRAWINGS

FIG. 1 is a block diagram representation of a fastener design and analysis system according to an exemplary disclosed embodiment;

FIG. 2A illustrates an interface selection screen according to an exemplary disclosed embodiment;

FIG. 2B illustrates a data entry form interface according to an exemplary disclosed embodiment;

FIG. 2C illustrates a computer aided drafting tool interface according to an exemplary disclosed embodiment; and

FIG. 3 is a flowchart depicting an exemplary process for designing and analyzing fasteners and a fastened joint.

### DETAILED DESCRIPTION

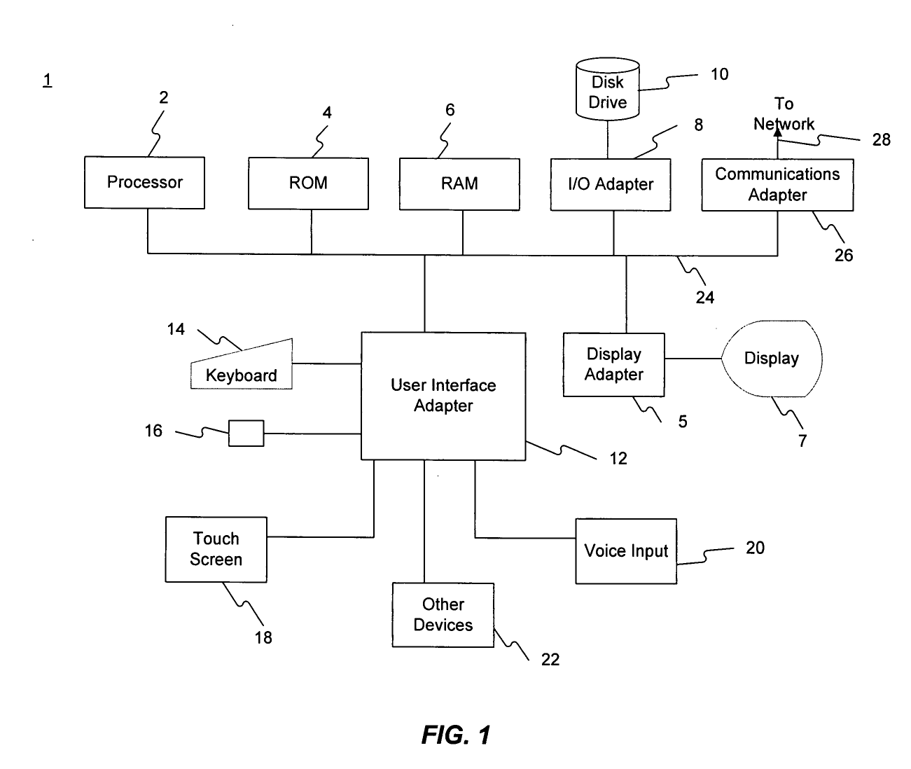

FIG. 1 is a block diagram of a host computer system 1 capable of implementing the methods and systems disclosed. Host computer system 1 may include a group of computer programs, program modules, and computer readable data stored on a computer readable media operating to cause computer system 1 to perform the actions described herein. Host computer system 1 may include a desktop or portable computer, a workstation, a server, a personal digital assistant, or any other computer system. Host computer system 1 may include a processor 2, a read-only memory (ROM) 4, a random access memory (RAM) 6, an input/output (I/O) adapter 8 for connecting peripheral devices such as disk drives 10, a user interface adapter 12 for connecting input devices such as a keyboard 14, a mouse 16, a touch screen 18, a voice input 20 and/or other devices 22 to a system bus 24. A communications adapter 26 may connect host computer system 1 to a network 28, and a display adapter 5 may connect system bus 24 to a display 7.

In an exemplary embodiment, the disclosed methods and systems may be implemented as a computer program running on a computer. Furthermore, the methods and systems disclosed herein may be implemented using numerous operating environments such as, but not limited to, DOS, Linux, Windows, VMS, VAX, BeOS, Solaris, OS/2, Macintosh, UNIX, and any future developed operating systems.

Processor 2 may execute instructions associated with an analysis tool which may be stored on disk drive 10, in RAM 6, or any other suitable location (e.g., a network location). The analysis tool may receive input parameters related to fasteners and fastened joints to enable an analysis of the fasteners and the fastened joints. The analysis tool may analyze the fasteners and fastened joints by applying the input parameters to formulas related to determining characteristics and behaviors of the fasteners and fastened joint under particular conditions. Processor 2 may then present output from the analysis tool (to display 7, for example) in the form of information related to the characteristics and behaviors.

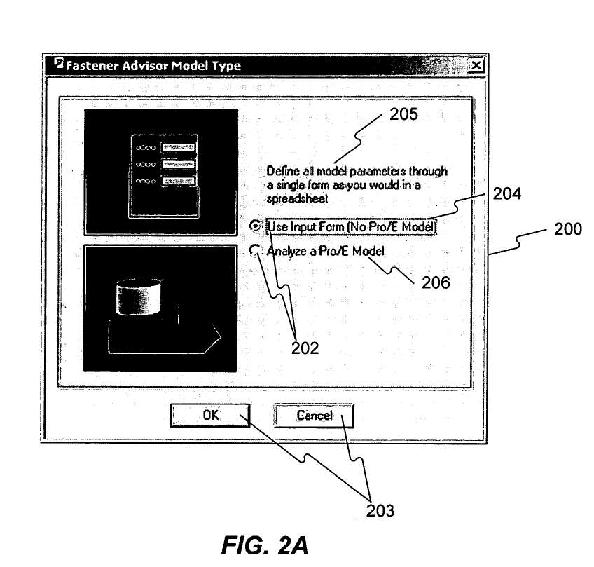

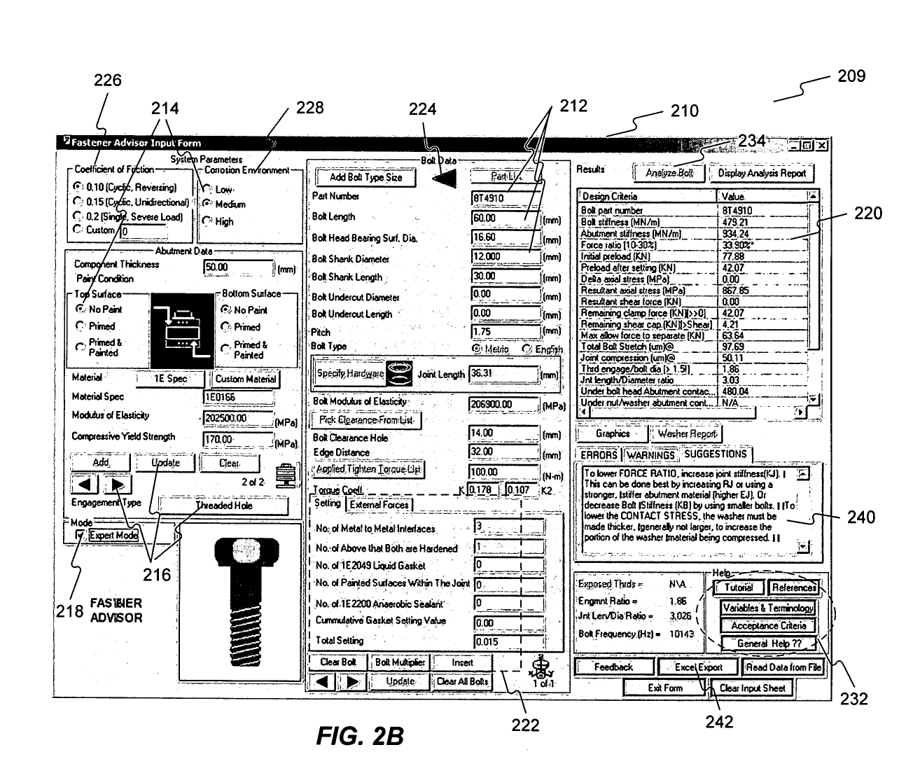

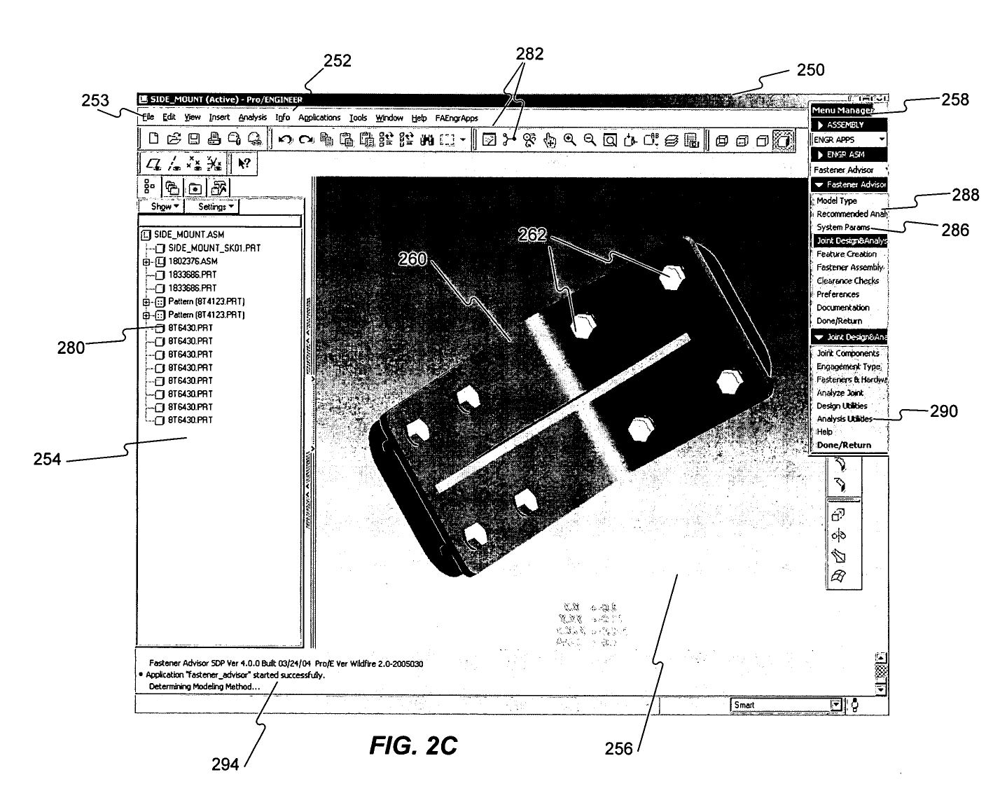

FIG. 2A illustrates an interface selection screen according to an exemplary disclosed embodiment. Processor 2 may cause display 7 to provide selection screen 200, which may prompt a user to select an interface for interacting with the analysis tool. For example, available interfaces may include a first interface which includes at least one data entry form and a second interface associated with a computer aided drafting tool (CAD interface). Selection screen 200 may enable selection of an interface by any method consistent with selection screen design. In one embodiment, selection screen 200 may display labeled radio buttons 202 and pushbuttons 203 to enable a selection. In such an embodiment, selection of data interface radio button 204 may indicate a user's selection of a first interface including at least one data entry form, whereas selection of CAD interface radio button 206 may indicate a user's selection of a second interface associated with a computer aided drafting tool. Alternatively, checkboxes, hyperlinks, tabs, etc. may be presented to allow a user to select an interface. Any number of additional interface options may be provided for selection on selection screen 200.

Further, selection screen 200 may provide access to additional information (e.g., text, a help file, or graphic displays), which may assist a user in making a selection from the available interfaces. For example, text 205 may be included on selection screen 200 for providing additional instructions on display interface 200. Other methods for providing additional information may include, for example, pop-up dialogs and sound information.

FIG. 2B illustrates a data entry form interface according to an exemplary disclosed embodiment. In one embodiment, the analysis tool may include an interface 209 configured as a data entry form 210. Data entry form 210 may include data field textboxes 212, radio buttons 214, pushbuttons 216, checkboxes 218, tables 220, and tabs 222, among other things, enabling a user to enter and select data values associated with a set of parameters related to a component to be fastened. The set of parameters may include a coefficient of friction, a corrosion environment, component thickness, a paint condition, a material type, an engagement type, a potential fastener (and/or parameters associated with a potential fastener), external forces, and any other parameters related to analyzing a fastener for use in joining the component to be joined with another component. Additional parameters may also be entered within data entry form 210 including, for example, clearance to other objects, fastener hardware, and measurement units. Data values may include numbers or text representations of a particular condition (e.g., modulus of elasticity in MPa, painted mating surface, etc.) and may or may not be limited by a predetermined range. Further, data values may be entered or selected on data entry form 210 through keyboard 14, mouse 16, touch screen 18, voice input 20, other devices 22, or any other suitable method.

Data entry form 210 may be configured to guide a user through the parameter entry process allowing entry of one or more parameters at a time. In one embodiment, a user may enter data for parameters in a predetermined order and may receive assistance from the interface during the data entry. In such an embodiment, a current parameter indicator 224 may indicate the current parameter to be entered. For example, a coefficient of friction parameter 226 may be selected before proceeding to selection of a corrosion environment parameter 228. Therefore, current parameter indicator 224 may point to coefficient of friction parameter 226, while entry fields for other parameters (e.g., corrosion environment 228) may be locked pending selection of coefficient of friction parameter 226. Once a user has selected a coefficient of friction, the selection field for the next parameter (e.g., corrosion environment 228) may become enabled, with current parameter indicator 224 moving to the next parameter accordingly. The field for coefficient of friction may then be locked. This process may continue until the desired parameters have been entered.

Alternatively, a user may be stepped through the parameter entry process using a series of “wizard” style question and answer screens. For example, a modal dialog prompting a user for entry of a first parameter (e.g., coefficient of friction) may be presented thereby preventing access to other data entry fields on data entry form interface 210. The wizard screen may contain information related to making a selection for the prompted parameter. Such information may include values based on previously selected values, standards/best practices for fastener design, and general parameter description information.

Following specification of a value for a parameter on a wizard screen, processor 2 may cause another parameter to be prompted in question and answer style. In this way, the user may be guided through the parameter entry process until the questions have been exhausted or until enough parameters have been entered to satisfy the analysis tool. One of skill in the art will recognize that guided parameter entry may be implemented using other methods and remain within the scope of this disclosure.

A user may obtain assistance with selecting parameters during interaction with an interface. For example, access to an information resource such as a help file, website, or tutorial may be provided within data entry form 210 through pushbuttons 232. Additionally, access to information resources may be enabled using hyperlinks, tabs, or other suitable method.

Upon actuating the request for an information resource, a user may review information related to, for example, the current parameter selection, the fastener design process, or may engage in a tutorial related to the operation of the fastener analysis tool/interface.

Additional assistance may also be provided in the form of a “standard” value or range of values for each parameter to be entered. Such a “standard” value or range of values may correlate with previous design standards implemented within a corporation or within the fastener design art. The user may elect to choose the provided value or, alternatively, change the value to meet the present criteria. For example, a user engaged in parameter entry may be presented with a standard range for torque coefficient. The user may recognize that such a range may not be appropriate for the current application and may, therefore, change the range to a more suitable value. Where a user enters values that may potentially conflict with other design considerations, processor 2 may cause a warning to be generated and displayed to the user.

Additionally, a user engaged in a wizard process may be presented with help file references on each question and answer screen or may disable the display of such information. One of skill in the art will recognize that other methods for providing access to information related to design selections may be used without departing from the scope of this disclosure.

In another embodiment, a user may select to enter parameters related to a fastened joint within data entry form 210 in “expert” mode. A user may select to operate in expert mode by, for example, checking checkbox 218 within data entry form 210, or by indicating such a preference through another suitable method. Expert mode may allow a user to perform parameter entry in any order and without suggestion or limitations of particular values and ranges for a parameter. For example, an expert user (e.g., an engineer) may be aware of particular values (e.g., standards typically used) that may result in a desired outcome for a particular joint to be fastened. Such an expert user may override values as desired and without checks or warning from the interface. An expert user may also access additional information related to parameter selection via pushbuttons, hyperlinks, etc.

Once a user has provided a set of parameters related to a component to be fastened in a fastened joint, the user may initiate an analysis of fasteners and the associated fastened joint from within data entry form interface 210. Analysis may be initiated by, for example, selecting a menu option to analyze, clicking an analysis pushbutton 234, or via any other suitable method for indicating a user's preference to begin the analysis.

Initiation of an analysis by a user may cause processor 2 to execute instructions associated with the analysis tool. In one embodiment, such instructions may cause processor 2 to provide the set of parameters entered in data entry form 210 to the analysis tool as variable input for performance of calculations related to analyzing fasteners and a fastened joint. Calculations may include, for example, determining stresses applicable to a potential fastener or fasteners, applying simulated external forces to a fastened joint, performing stiffness calculations, determining fastener preload, and determining fastener torque, among other things. Calculations related to an analysis may be performed using associated formulas currently available in the art and related to fastener and fastened joint analysis. One of ordinary skill in the art will recognize that various formulas for analyzing a fastened joint may change as a result of research seeking to improve such formulas. Use of such future developed formulas remains within the scope of this disclosure.

Analysis of fasteners and a fastened joint may also include performing multiple types of analyses using the set of parameters for a fastened joint. For example, analyses may include a single fastener using a single-bolt analysis or many fasteners using a rigid body analysis. Various types of analysis may simulate external loads upon the fastened joint, as specified, or may analyze the joint in isolation. A rigid body analysis assumes the related components within the joint are rigid bodies. A rigid body may be an idealization of a solid body of finite size in which deformation is neglected. In other words, the distance between any two given points of a rigid body remains constant regardless of external forces exerted on it.

Following analysis by the analysis tool, CPU 2 may cause an output of the analysis tool to be displayed on display 7. Output from the analysis tool may be displayed, for example, within data entry form 210, in a separate form, or exported to an external application for review using export pushbutton 242. Within data entry form 210, analysis output may be displayed using output table 220.

Output from the analysis tool may include values related to, for example, a recommended fastener, a fastener stiffness, a component stiffness, a force ratio, an initial preload for the fastener, recommended torque, a preload following application of the recommended torque, a total fastener stretch, and numerous other values of interest to one skilled in the art performing such an analysis. For example, an analysis may determine that a selected fastener torque is inadequate given the load parameters specified. The analysis may provide a output specifying a new torque value to be used with the selected fastener.

Additionally, output may include errors, warnings, optimizations, and suggestions related to the set of parameters and analysis. For example, a specified bearing surface may have been identified as too small during the analysis. Results may include a suggestion for additional fastener hardware (e.g., washers) for increasing the bearing surface. Display 7 may display such information in for example, tabbed output 240. Alternatively, such output may be displayed as pop-ups or warning dialog boxes on display 7 and may be accompanied by a sound or other feature to attract attention of the user.

FIG. 2C illustrates a computer aided drafting tool interface 250 according to an exemplary disclosed embodiment. Computer aided drafting may include the use of a wide range of computer-based tools that assist engineers, architects and other design professionals in their design activities. Currently, available packages range from 2D vector based drafting systems to 3D parametric surface and solid design modelers. CAD has many uses and may be used in the design of tools, machinery, and the design and manufacture of components and fastened joints, among other things. In one embodiment, CAD tool interface 250 may provide a link to or an interface for the Pro/ENGINEER® software package.

CAD tool interface 250 may contain various options and functionality related to designing and drafting components and fasteners for fastened joints. In one embodiment, CAD tool interface 250 may include a tool menu 252, a property window 254, a rendering area 256, and a fly-out menu 258. Tool menu 252 may present options related to various functionality within a CAD tool. Options presented on tool menu 252 may include, for example, tools for designing and drafting a component, parameter specification (e.g., paint condition, potential fasteners, etc), and file access.

In one embodiment, a user may use file menu 253 to open a component file containing data related to a component to be joined that was previously modeled within a CAD tool. Where a user opens a component previously modeled within a CAD tool, the component, as well as parameters associated with the component, may be modified or redesigned based on a determination of the user. For example, component 260 may require additional fasteners be added at fastener positions 262 to compensate for a particular load. A user may implement additional fasteners as desired within CAD tool interface 250 using property window 254, rendering window 256, or other functionality available within CAD tool interface 250.

Alternatively, a new component may be modeled within CAD tool interface 250 using the various drafting functions available. One of skill in the art will recognize that various CAD tools enable drafting and parameter specification through different mechanisms and use of any and all such mechanisms falls within the scope of the present disclosure. Using available functionality, a user may design and draft components to be fastened in a fastened joint. The user may also specify a number of fasteners, their position on a designed component, and properties associated with the fasteners and component while drafting within rendering window 256.

Alternatively, parameters associated with a component or fastener may be specified using functions associated with property window 254. For example, a user may expand component identifier 280 revealing parameters associated with the component represented by component identifier 280. Once expanded, the user may modify or add values as desired. Alternatively, a user may click component identifier 280 resulting in display of an additional property window allowing modification or addition of parameter values associated with the component represented by component identifier 280. Other methods for parameter modification may be available, for example from fly-out menu 258 using fly-out option 286.

Parameters associated with a component represented by component identifier 280 may include a coefficient of friction, a corrosion environment, component thickness, a paint condition, a material type, an engagement type, a potential fastener (and/or parameters associated with a potential fastener), external forces, and any other parameters related to analyzing a fastener for use in joining the component to be joined with another component. Additional parameters including, for example, clearance to other objects, fastener hardware, and measurement units may be calculated and provided by CAD tool interface 250.

Parameters may be manually entered during design or modification of a component model or may be determined and provided by CAD tool interface 250. For example, a user may specify during drafting of a component, that one side of the component will be painted with anti-oxidizing paint. This parameter may apply to the paint condition parameter and may be provided by CAD tool interface 250 to the analysis tool to satisfy entry of that parameter. Further, other components may be created (i.e., drafted) near a joint to be analyzed. CAD tool interface 250 may therefore determine the distance (i.e., clearance) to other objects based on the position of the component to be joined, the selected fastener, and other objects existing near the component. The resulting value may then be provided as a clearance-to-other-objects parameter. Other parameters such as the type of environment (e.g., a corrosive environment) may be specified explicitly by the user.

During operation within the CAD tool interface 250, a user may have access to various options associated with the analysis tool. Access to such functionality may be available via a toolbar button 282, fly-out menu 258, or other suitable method. Functionality may include recommendation of a potential fastener, access to fastener design help, and initiation of an analysis. For example, a user desiring a recommendation for a fastener to use at fastener position 262 may select fly-out option 288 from fly-out menu 258. This may cause processor 2 to execute instructions related to the analysis tool, which in turn may cause a series of potential fasteners to be provided to the user for selection.

Once a user has completed drafting/modifying a component to be fastened in a fastened joint, the user may initiate an analysis of the fasteners and joint from within CAD tool interface 250. Analysis may be initiated by, for example, selecting a menu option to analyze and selecting fly-out option 290 on fly-out menu 258.

Initiation of an analysis by a user may cause processor 2 to execute instructions associated with the analysis tool. Such instructions may cause processor 2 to provide the set of parameters from CAD tool interface 250 to the analysis tool as variable input for performance of calculations related to analyzing fasteners and a fastened joint. Calculations may include, for example, determining stresses applicable to a potential fastener or fasteners, applying simulated external forces to a fastened joint, performing stiffness calculations, determining fastener preload, determining fastener clearance, and determining fastener torque, among other things. Calculations related to an analysis may be performed using associated formulas currently available in the art and related to fastened joint analysis. One of ordinary skill in the art will recognize that various formulas for analyzing a fastened joint may change as a result of research seeking to improve such formulas. Use of such future developed formulas remains within the scope of this disclosure.

Analysis of fasteners and a fastened joint may also include performing multiple types of analyses using a set of parameters for a fastened joint. For example, analyses may include a single fastener using single-bolt analysis or many fasteners using a rigid body analysis. Various types of analysis may simulate external loads upon the fastened joint as specified or may analyze the joint in isolation.

Following analysis by an analysis tool, processor 2 may cause output of the analysis to be displayed on display 7. Output from the analysis tool may be displayed within CAD tool interface 250, for example, on status bar 294, within rendering window 256, and/or within a separate panel. Further, output from the analysis tool may be displayed in a separate form, exported to an external application for review, or provided by any other method suitable for reviewing such output.

Output from the analysis tool may include values related to, for example, a recommended fastener, a fastener stiffness, a component stiffness, a force ratio, an initial preload for the fastener, recommended torque, a preload following application of the recommended torque, a total fastener stretch, and numerous other values of interest to one skilled in the art performing such an analysis. For example, an analysis may determine that a selected fastener torque was inadequate given the load parameters specified. The analysis may provide a output specifying a new torque value to be used with the selected fastener.

Additionally, output may include errors, warnings, optimizations, and suggestions related to the set of parameters and analysis. For example, a specified bearing surface may have been identified as too small during the analysis. Results may include a suggestion for additional fastener hardware (e.g., washers) for increasing bearing surface. Such output may be displayed within CAD tool interface 250 or within a separate form or window. Alternatively, such output may be display as pop-ups or warning dialog boxes on display 7 and may be accompanied by a sound or other feature to attract attention.

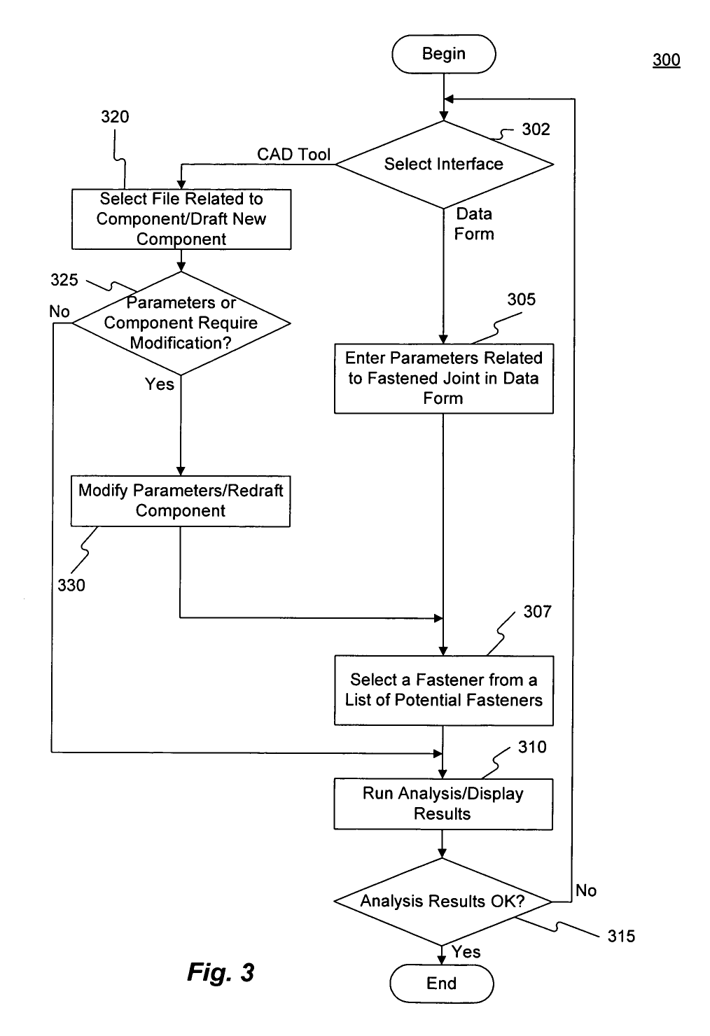

FIG. 3 is a flowchart depicting an exemplary process for designing and analyzing fasteners and a fastened joint. Upon starting the application, a user may be prompted to select an interface (step 302). For example, available interfaces may include a first interface (e.g., interface 209) which includes at least one data entry form and a second interface (e.g., CAD interface 250) associated with a CAD tool interface.

Where a user has selected an option for a data entry form interface, the user may be prompted to provide a set of parameters related to a component to be fastened (step 305). A user may also select a fastener from a list of potential fasteners as part of the parameter entry process (step 307). The list of potential fasteners may be determined by the analysis tool based on the component and the set of parameters provided by the user. For example, where a user has specified a highly corrosive environment, the analysis tool may provide a list of potential fasteners having appropriate corrosion resistance. The list of fasteners may be provided, for example, within data entry form 210 or in a separate window for selection. Further, the list of potential fasteners may be listed by part number or by other attribute as determined by a user. Alternatively, the user may rely upon the analysis tool to select the most appropriate fastener for the specified conditions.

After the set of parameters and a potential fastener have been selected, a user may initiate an analysis of the fasteners and associated fastened joint (step 310). The analysis may be initiated via any suitable method. A user may then review a set of results from the analysis for a determination of acceptability (step 315).

Where a user selects an option for a CAD tool interface, the user may be presented with CAD tool interface 250 on display 7. The user may then select a file containing a previously modeled component or draft a new component (step 320). For example, an analyst having several designs for components previously drafted by a designer may open one of the component designs for analysis. Alternatively, a designer may begin drafting a component for analysis from scratch within CAD tool interface 250.

Once a file containing data related to a component to be joined has been opened, or a new component has been created, a user may review the parameters and fasteners associated with the component for accuracy (step 325). For example, a previously drafted component may have been specified for use in a low corrosion environment, when the component will actually be used in a high corrosion environment. Alternatively, a potential fastener may have been selected during a previous drafting session that will not meet newly presented design criteria.

Where the user has identified an incorrect parameter or requires a fastener design change (step 325—Yes), the user may modify the data within the CAD tool interface 250 (step 330). Using the example from the previous paragraph, the user may correctly specify the corrosion parameter within the CAD tool interface 250 prior to initiating an analysis of the component and joint. Further, the user make wish to modify the selection of potential fasteners (step 307) following specification of new parameter values or design change.

Following parameter confirmation and fastener specification, an analysis of the component and fasteners may be initiated from within CAD tool interface 250 as described above with reference to step 310. The user may then review a set of results from the analysis (step 315).

Where the user determines that the parameters and design are appropriate (step 325—No), the user may proceed on to initiation of an analysis (step 310). The user may then review a set of results from the analysis (step 315).

### INDUSTRIAL APPLICABILITY

The disclosed system and method for designing and analyzing a fastened joint may be used to ease the task of fastener selection and specification for a fastened joint. In one exemplary disclosed embodiment, the system and method may be used to design a component and iteratively specify/analyze fasteners associated with the component in a fastened joint from within a single interface.

The presently disclosed system and method for designing and analyzing a fastened joint may have several other advantages. First, the disclosed system and method may allow a designer to specify fasteners which result in a well-designed joint while minimizing cost. For example, specification of a stainless steel bolt for a joint where a galvanized bolt would be adequate incurs unnecessary cost. Use of the presently disclosed systems and methods can eliminate this cost by providing analysis results targeted toward optimizing fastener selection under a particular set of conditions.

Moreover, because the disclosed system and method may permit nearly anyone to perform a fastener analysis, savings and efficiency are realized by delegating tasks to appropriate personnel. For instance, an analyst may perform numerous iterations of specifying fasteners for a particular joint and obtaining output results for each analysis. The analyst may then provide a uniform array of resulting fasteners to an engineer for final specification of an optimal fastener. In this way, the engineer is freed to perform other more valuable design tasks.

Further, because the disclosed system and method can integrate with a CAD tool, a designer may draft a component, receive fastener recommendations, and specify potential fasteners for a joint without switching between various applications to analyze a work in progress.

It will be apparent to those skilled in the art that various modifications and variations can be made in the disclosed fastener analysis methods and systems without departing from the scope of the disclosure. Additionally, other embodiments of the fastener analysis methods and systems will be apparent to those skilled in the art from consideration of the specification. It is intended that the specification and examples be considered as exemplary only, with a true scope of the disclosure being indicated by the following claims and their equivalents.

What is claimed is:

1. A computer system comprising:
a display; and
a processor configured to:
provide a first interface and a second interface to the display;
receive, via the first or second interface, a set of parameters associated with a component to be fastened;
provide the set of parameters to an analysis tool;
execute instructions associated with the analysis tool; and
provide an output of the analysis tool to the display via either the first or second interface;
wherein the first interface includes at least one data entry form, and the second interface is associated with a computer aided drafting tool.

2. The computer system of claim 1, wherein the set of parameters includes data provided by a user to the data entry form.

3. The computer system of claim 1, wherein the set of parameters includes attributes associated with a model of the component.

4. The computer system of claim 3, wherein the attributes are determined based on information provided by the computer aided drafting tool related to the model of the component.

5. The computer system of claim 2, wherein a data field within the data entry form displays a suggested predetermined value related to a parameter within the set of parameters.

6. The computer system of claim 2, wherein a first data field within the data entry form is locked pending receipt of data in a second data field within the data entry form.

7. The computer system of claim 2, wherein a value for the data is limited by a predetermined range.

8. The computer system of claim 2, wherein at least one parameter of the set of parameters is received via a prompt for the at least one parameter.

9. The computer system of claim 1, wherein the output includes at least one of a suggested fastener, a suggested fastener torque, a resultant load, and a suggested fastener hardware.

10. The computer system of claim 9, wherein the set of results are displayed within the first interface.

11. The computer system of claim 9, wherein the set of results are displayed within the second interface.

12. The computer system of claim 1, wherein the first interface includes at least one data field for entering at least one parameter for the set of parameters.

13. The computer system of claim 1, wherein the first interface further includes a table configured to display the output.

14. The computer system of claim 1, wherein the processor is further configured to provide a list of potential fasteners based on the set of parameters.

15. The computer system of claim 1, wherein the output includes a result of at least one of a single-bolt analysis and a rigid body analysis based on the set of parameters.

16. A method for selectively designing and analyzing a fastener for a joint, the method comprising:
running a software analysis tool configured to provide a first interface and a second interface, wherein the first interface includes at least one data entry form, and the second interface is associated with a computer aided drafting tool;
selecting one of the first and the second interface;
providing, via the selected interface, a set of parameters related to a component to be fastened;
selecting a fastener from a list of potential fasteners;
initiating an analysis of the selected fastener and the component; and
reviewing, within the selected interface, a set of results generated by the analysis.

17. The method of claim 16, wherein the set of results includes at least one of a suggested fastener, a suggested fastener torque, a resultant load, and a suggested fastener hardware.

18. The method of claim 17, wherein the set of results are displayed within the first interface.

19. The method of claim 17, wherein the set of results are displayed within the second interface.

20. The method of claim 16, wherein the set of parameters includes data provided by a user to the data entry form.

21. The method of claim 16, wherein the set of parameters includes attributes associated with a model of the component.

22. The method of claim 21, wherein the attributes are determined based on information provided by the computer aided drafting tool related to the model of the component.

23. The method of claim 20, wherein the data entry form displays suggested predetermined values related to the set of parameters.

24. A computer-readable medium including instructions for performing a method for designing and analyzing a fastener for a joint, the method comprising:
receiving a selection of an interface from a group of interfaces, wherein the group of interfaces includes a computer aided drafting tool interface and a data entry form interface;
receiving, via the selected interface, a set of parameters related to a component to be fastened;
receiving a selection of a fastener for the joint;
analyzing the fastener based on the set of parameters and the component to be fastened, wherein the analyzing includes generating a set of results; and
outputting the set of results to the selected interface.
